(19) United States
(12) Patent Application Publication
(10) Pub. No.: US 2006/0069907 A1
(43) Pub. Date: Mar. 30, 2006

(54) Method for installing and reinstalling an operating system

(75) Inventors: Wei-Tsih Lee, Taipei Hsien (TW); Huey-June Lee, Taipei Hsien (TW)

Correspondence Address: FOLEY AND LARDNER LLP;SUITE 500, 3000 K STREET NW, WASHINGTON, DC, 20007, US

(73) Assignee: ACER INC.

(21) Appl. No.: 11/025,927

(22) Filed: Jan. 3, 2005

(30) Foreign Application Priority Data
Sep. 15, 2004 (TW) 093127880

(51) Int. Cl. G06F 9/00

(52) U.S. Cl. 713/2

(57) ABSTRACT

A method for installing an operating system in a computer includes: enabling the computer to execute a bootstrapping program; enabling the computer to configure a storage device thereof with a system partition and an operating partition, and to make a backup of the bootstrapping program and an operating system loading program in the system partition; and enabling rebooting of the computer through the bootstrapping program, and subsequently enabling the computer to execute the operating system loading program for loading an operating system program to the operating partition, and to set the system partition as a hidden partition. When integrity of the operating system program in the operating partition has been compromised, the computer can be rebooted through the bootstrapping program in the system partition, and the operating system program in the system partition can be executed so as to reload the operating system program to the operating partition.

### CROSS-REFERENCE TO RELATED APPLICATION

This application claims priority of Taiwanese application no. 093127880, filed on Sep. 15, 2004.

### BACKGROUND OF THE INVENTION

1. Field of the Invention

The invention relates to a method for installing an operating system in a computer, more particularly to a method that can simplify and hasten reinstallation of an operating system in a computer.

2. Description of the Related Art

FIG. 1 illustrates a conventional process for reinstalling an operating system in a computer. First, in step 11, when the integrity of an operating system program stored in a hard disk of the computer has been compromised, a system bootstrapping disc is placed in an optical disc drive of the computer, and a bootstrapping program stored in the disc is executed to boot the computer. Next, in step 12, the hard disk is configured with system and operating partitions, and the bootstrapping program and an operating system loading program stored in the disc are loaded to the system partition. Subsequently, in step 13, the computer is shut down, the system bootstrapping disc is removed, and an operating system disc is placed in the optical disc drive. Next, in step 14, the computer is reactivated so as to reboot the computer through the bootstrapping program stored in the system partition, and the operating system loading program stored in the system partition is executed thereafter. Then, in step 15, an operating system program stored in the operating system disc is read and loaded to an operating partition of the hard disk. When the loading operation is completed, the system partition is deleted.

Finally, in step 16, the computer is shut down and is reactivated so as to reboot the computer using the operating system program in the operating partition. The reinstallation procedure of the operating system in the computer is deemed to be complete if the computer is rebooted successfully.

In the conventional process, there is always a need to place a system bootstrapping disc, reconfigure a hard disk with system and operating partitions, and proceed with complicated and tedious configuration tasks each time an operating system is to be reinstalled in a computer. It is noted that the task of configuring device and system parameters is a complicated one for most computer users. There is thus a need to find ways to simplify and hasten reinstallation of an operating system in a computer.

### SUMMARY OF THE INVENTION

Therefore, the main object of the present invention is to provide a method for installing and reinstalling an operating system in a computer that can overcome the aforesaid drawbacks associated with the prior art.

According to one aspect of the present invention, there is provided a method for installing an operating system in a computer. The method comprises the steps of:
a) enabling the computer to read a first storage medium that contains a bootstrapping program and an operating system loading program, and to execute the bootstrapping program;
b) enabling the computer to configure a storage device thereof with a system partition and an operating partition, and to make a backup of the bootstrapping program and the operating system loading program contained in the first storage medium in the system partition; and
c) enabling rebooting of the computer through the bootstrapping program stored in the system partition, and subsequently enabling the computer to execute the operating system loading program stored in the system partition for reading a second storage medium that contains an operating system program and for loading the operating system program to the operating partition of the storage device, and to set the system partition as a hidden partition.

According to another aspect of the present invention, there is provided a method for reinstalling an operating system in a computer that has a storage device configured with an operating partition and a hidden partition. The hidden partition has a bootstrapping program and an operating system loading program stored therein. The method comprises the steps of:
a) enabling the computer to access the hidden partition of the storage device and to reboot through the bootstrapping program in the hidden partition; and
b) enabling the computer to execute the operating system loading program in the hidden partition so as to load an operating system program to the operating partition of the storage device.

According to yet another aspect of the present invention, there is provided a method for reinstalling an operating system in a computer that includes a baseboard management controller and a storage device configured with an operating partition and a hidden partition. The hidden partition has a bootstrapping program and an operating system loading program stored therein. The method comprises the steps of:
a) configuring the baseboard management controller of the computer to enable a remote system administrator platform to set system boot option parameters;
b) based on the system boot option parameters set by the remote system administrator platform, enabling a Basic Input/Output System (BIOS) of the computer to access the hidden partition, and subsequently enabling the computer to execute the bootstrapping program in the hidden partition; and
c) enabling the computer to provide a service item menu including a set of service items available for selection, and to execute operations associated with a selected one of the service items.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart of a conventional method for reinstalling an operating system in a computer;

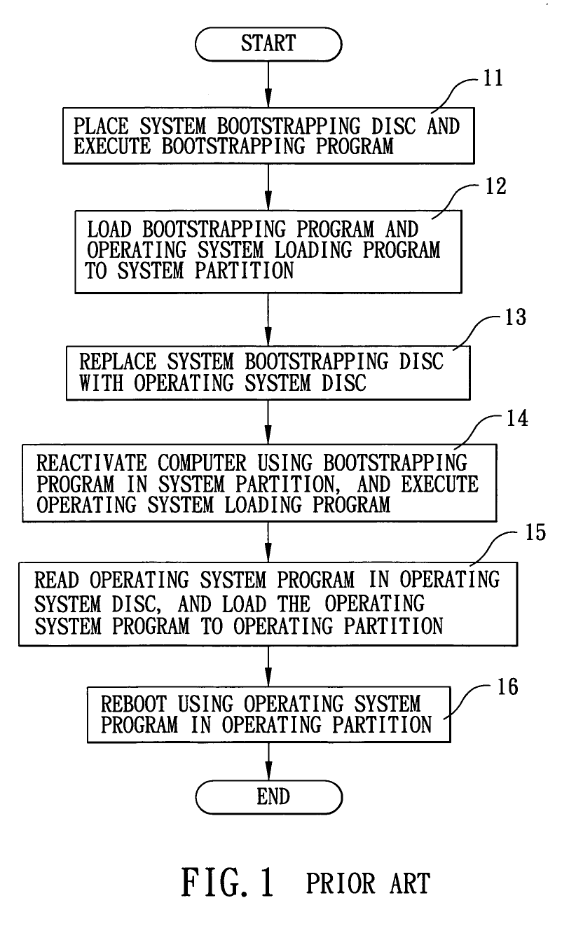

FIG. 2 is a flowchart of the preferred embodiment of a method for installing an operating system in a computer according to the present invention;

FIG. 3 is a flowchart of the preferred embodiment of a method for local reinstallation of an operating system in a computer according to the present invention; and

FIG. 4 is a flowchart of the preferred embodiment of a method for remote reinstallation of an operating system in a computer according to the present invention.

### DETAILED DESCRIPTION OF THE PREFERRED EMBODIMENT

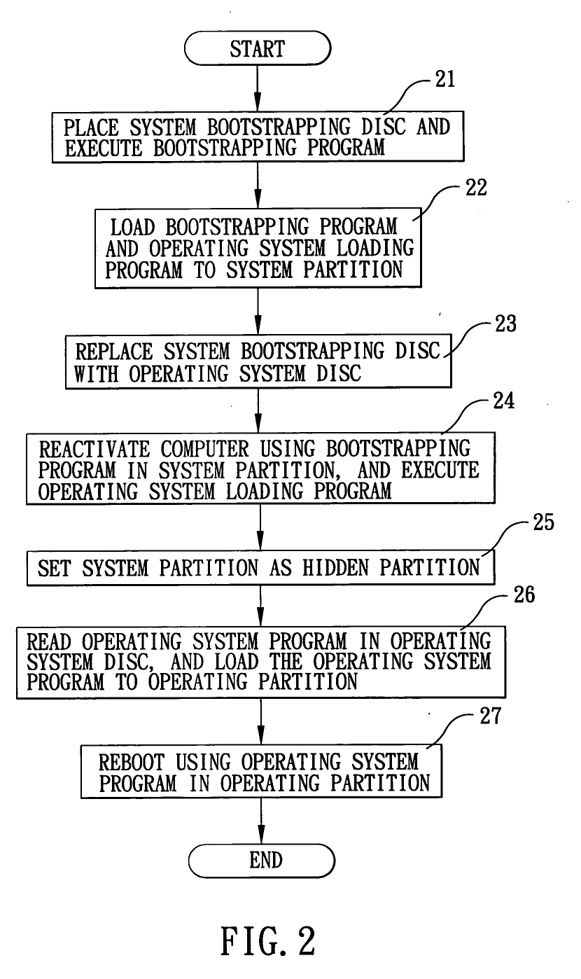

FIG. 2 illustrates the preferred embodiment of a method for installing an operating system for the first time in a computer. First, in step 21, before activating the computer, a system bootstrapping disc containing a bootstrapping program and an operating system loading program is placed in an optical disc drive of the computer. The computer is then activated so that the Basic Input/Output system (hereinafter referred to as BIOS) of the computer enables operation of the optical disc drive, and so that the computer can boot through the bootstrapping program stored in the system bootstrapping disc. Next, in step 22, the computer is enabled so as to configure a storage device (such as a hard disk) thereof with system and operating partitions, and a backup of the bootstrapping program and the operating system loading program stored in the system bootstrapping disc is made by loading the same to the system partition of the storage device. Subsequently, in step 23, the system bootstrapping disc is replaced with an operating system disc. Next, in step 24, the computer is shut down and is reactivated so that the BIOS of the computer is able to select the bootstrapping program in the system partition for booting the computer and so that the computer is able to execute the operating system loading program in the system partition. At the same time, in step 25, the system partition is set as a hidden partition. To this end, the address of the system ID entry corresponding to the system partition and found in the partition table (i.e., present in cylinder 0, head 0 and sector 1 of the hard disk) is modified as follows:

Set “byte offset 04h: system ID=7Fh”

In this manner, while a hard disk managing tool of the operating system, such as the hard disk manager of Windows®, deems the system partition to be a hidden partition, the file system table, the FAT16/32 table, the system hierarchy structure, etc., that were previously established in the system partition still exist in the hidden partition. The tool for changing the system ID can be implemented as an application interface in any operating system platform, such as DOS, Windows, Linux, etc., that can initiate BIOS INT 13 (i.e., disk I/O interface, providing read/write and formatting services of floppy and hard disks) or that can provide services similar to DOS INT 21 (i.e., an application program service interface in MS-DOS).

Thereafter, in step 26, the operating system loading program enables the computer to read an operating system program stored in the operating system disc, and to load the operating system program to the operating partition of the storage device. The operating partition is then set as the default system bootstrapping path for the BIOS.

Finally, in step 27, the computer is shut down and is reactivated. Since the BIOS does not see the system partition, rebooting of the computer proceeds using the operating system program in the operating partition.

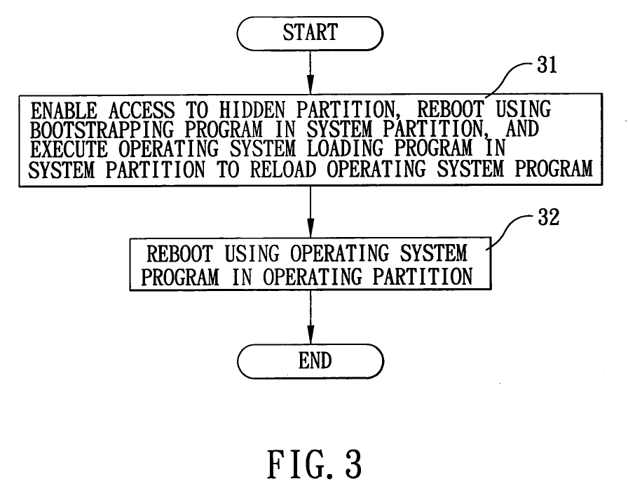

It is apparent from the foregoing that, when the operating system is installed for the first time in the computer, unlike the aforementioned prior art that involves deleting the system partition having the bootstrapping program and the operating system loading program stored therein, the system partition is instead set as a hidden partition in the method of this invention. Thereafter, when the integrity of the operating system program in the operating partition of the storage device has been compromised, repair of the operating system of the computer can be conducted using the method shown in FIG. 3. Particularly, in step 31 of FIG. 3, the computer is provided with a hot key (such as the “F4” key) that is operable so as to enable the BIOS of the computer to access the hidden partition when the BIOS executes a Power-On Self-Test (POST), thereby enabling operation of the computer for rebooting through the bootstrapping program in the hidden partition and for executing the operating system loading program in the hidden partition. At this time, if a backup of the operating system program was made in the system partition when the operating system was installed for the first time in the computer, the operating system loading program enables the computer to reload the operating system program in the system partition to the operating partition of the storage device of the computer. Otherwise, the operating system loading program enables the computer to read the operating system program from the operating system disc that was placed in the optical disc drive of the computer and to reload the operating system program to the operating partition. Then, in step 32, after reloading of the operating system program has been completed, the computer is shut down and is reactivated so as to reboot the computer using the operating system program in the operating partition of the storage device. The reinstallation procedure of the operating system in the computer is deemed to be complete if the computer is rebooted successfully.

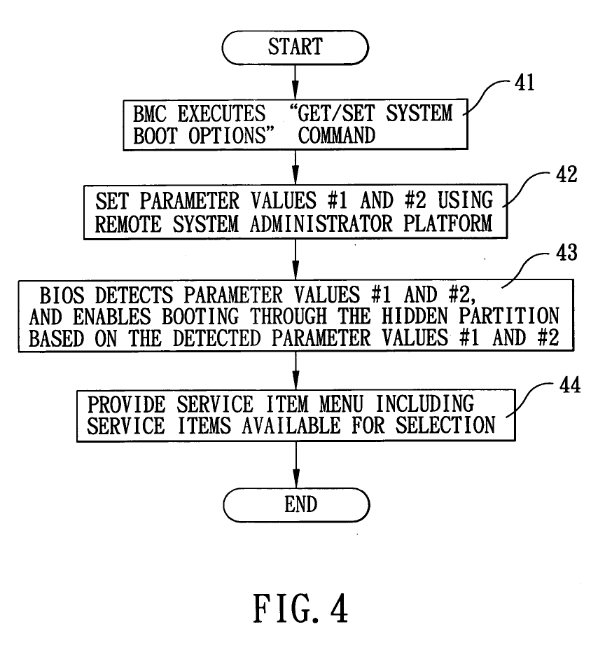

The method of FIG. 3 involves local reinstallation of the operating system. As shown in FIG. 4, the preferred embodiment further contemplates remote reinstallation of the operating system. In the method of FIG. 4, repair of the operating system of the computer can be conducted with the assistance of a remote system administrator platform under the condition that, in the aforesaid step 22 of FIG. 2, the system bootstrapping disc must provide an interface for the user to setup an address of a network optical disc drive, and that these settings as well as the requisite optical disc drive information must be stored in the system partition (that is, the hidden partition).

In step 41 of FIG. 4, under the condition that the computer includes a baseboard management controller (hereinafter referred to as BMC), the BMC executes a “get/set system boot options” command, which is defined by the Intelligent Platform Management Interface (IPMI) specification version 1.5. The contents of the command are shown in the following table:

| Parameter | Parameter | |
|---|---|---|
| name | value | Parameter data and description |
| Service | #1 | #1 is the basis for selection by the BIOS |
| partition | | of the service partition to be used during |
| Selector | | booting. In this embodiment, the system ID of |
| | | the hidden partition is set to 7Fh. By setting |
| | | the parameter value #1 to 7Fh, the BIOS will |
| | | enable system booting through the hidden |
| | | partition. |
| Service | #2 | #2 = 1: BIOS seeks a specific service |
| partition | | partition |
| scan | | #2 = 0: BIOS located a specific service |
| | | partition |
| Boot | #7 | #7 = 0 h: Wait for an operating system |
| initiator | | command when there is no other event after |
| mailbox | | booting through the hidden partition. |
| | | #7 = 1 h: Automatic loading of an |
| | | operating system program from a local optical |
| | | disc drive after booting through the hidden |
| | | partition. |
| | | #7 = 2 h: Automatic loading of an |
| | | operating system program from a remote network |
| | | optical disc drive after booting through the |
| | | hidden partition. |
| | | #7 = 3 h: Perform system diagnostics |
| | | after booting through the hidden partition. |

Next, in step 42, the BMC enables the remote system administrator platform to set the parameter values #1 and #2 in the “get/set system boot options” command. In this manner, when it is desired to perform operating system repair, the remote system administrator platform will set up the parameter value #1 as 7Fh, and the parameter value #2 as 0. Then, in step 43, after reactivating the computer, in response to detection by the BIOS of the computer that the parameter value #1 is set to 7Fh and the parameter value #2 is set to 0, the BIOS first clears the parameter value #1 and the parameter value #2 (so as to prevent booting through the hidden partition during subsequent reactivation of the computer), and then enables booting of the computer through the bootstrapping program in the hidden partition. Accordingly, if none of the parameter values in the BMC were set up using the remote system administrator platform, the BIOS will enable booting of the computer through the default booting procedure.

Subsequently, in step 44, after booting through the hidden partition, a pre-established program is executed by the computer so as to provide a service table, which includes a set of service items, on a display interface of the computer. The service items include:

1. Wait for an operating system command.

2. Operating system repair through a local optical storage device.

3. Operating system repair through a network optical storage device.

4. Execute system diagnostics program.

The aforesaid service items are related to the parameter value #7 of the “get/set system boot options” command. When one of the service items is selected, the parameter value #7 will be set to correspond with the selected service item. For example, when the service item (2) is selected, the parameter value #7 is set to 1h, such that, after the BIOS detects the parameter value #7, it will proceed to execute the operating system loading program in the hidden partition, and enable the computer to retrieve an operating system program stored in an operating system disc that was placed in the local optical storage device of the computer and to load the operating system program to the operating partition. On the other hand, when the service item (3) is selected, the parameter value #7 is set to 2h, such that, after the BIOS detects the parameter value #7, it will proceed to execute the operating system loading program in the hidden partition, and enable the computer to look for the network optical storage device through the BMC based on the address of the network optical storage device recorded in the hidden partition. The computer then retrieves an operating system program stored in an operating system disc that was placed in the network optical storage device of the computer, and loads the operating system program that was retrieved through the BMC to the operating partition. Accordingly, operating system repair is possible through the assistance of the remote system administrator platform.

Moreover, when the BIOS detects that the parameter value #7 is set to 0h, after booting through the hidden partition, the computer simply waits for an operating system command. Furthermore, when the BIOS detects that the parameter value #7 is set to 3h, after booting through the hidden partition, the computer will execute a Power-On Self Test (POST) routine (i.e., the system diagnostics program).

It is worth noting that, if the BMC of the computer provides a text mode console redirection function, the remote system administrator platform can utilize this function to monitor remotely the system operating status.

In sum, this invention provides a method in which, when an operating system is installed for the first time in a computer, a system partition that was established in a hard disk of the computer and that stores a bootstrapping program and an operating system loading program retrieved from an operating system disc is set as a hidden partition. Thereafter, when the integrity of an operating system program in an operating partition of the hard disk has been compromised, the user is able to permit the BIOS of the computer to access the hidden partition through mere operation of a hot key. As a result, the BIOS is able to boot the computer through the bootstrapping program in the hidden partition, and to execute the operating system loading program in the hidden partition so that the operating system program resident in the hidden partition or in an operating system disc can be reloaded to the operating partition of the hard disk, thereby facilitating repair of the operating system. Moreover, the method of this invention, through the BMC of the computer, enables a remote system administrator platform to set system boot option parameters, i.e., the parameter values #1 and #2 of the “get/set system boot options” command, so as to enable the BIOS to select the hidden partition when booting the computer. In addition, the mode of operating system repair can be selected through the parameter value #7 of the “get/set system boot options” command. Therefore, operating system repair through the assistance of the remote system administrator platform is also possible in the method of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for installing an operating system in a computer, comprising the steps of:
a) enabling the computer to read a first storage medium that contains a bootstrapping program and an operating system loading program, and to execute the bootstrapping program;
b) enabling the computer to configure a storage device thereof with a system partition and an operating partition, and to make a backup of the bootstrapping program and the operating system loading program contained in the first storage medium in the system partition; and
c) enabling rebooting of the computer through the bootstrapping program stored in the system partition, and subsequently enabling the computer to execute the operating system loading program stored in the system partition for reading a second storage medium that contains an operating system program and for loading the operating system program to the operating partition of the storage device, and to set the system partition as a hidden partition.

2. The method of claim 1, further comprising the steps of:
enabling the computer to make a backup of the operating system program contained in the second storage medium in the system partition; and
when integrity of the operating system program in the operating partition of the storage device has been compromised, enabling operation of the computer for rebooting through the bootstrapping program in the system partition and for executing the operating system loading program in the system partition so as to reload the operating system program in the system partition to the operating partition of the storage device.

3. The method of claim 2, wherein the computer is provided with a hot key that is operable so as to enable a Basic Input/Output System (BIOS) of the computer to access the hidden partition when the BIOS executes a Power-On Self-Test (POST) in the event that the integrity of the operating system program in the operating partition of the storage device has been compromised.

4. The method of claim 1, further comprising the step of:
when integrity of the operating system program in the operating partition of the storage device has been compromised, enabling operation of the computer for rebooting through the bootstrapping program in the system partition and for executing the operating system loading program in the system partition so as to reload the operating system program in the second storage medium to the operating partition of the storage device.

5. The method of claim 4, wherein the computer is provided with a hot key that is operable so as to enable a Basic Input/Output System (BIOS) of the computer to access the hidden partition when the BIOS executes a Power-On Self-Test (POST) in the event that the integrity of the operating system program in the operating partition of the storage device has been compromised.

6. The method of claim 1, wherein the storage device of the computer is a hard disk.

7. The method of claim 1, wherein each of the first and second storage media is an optical disc.

8. A method for reinstalling an operating system in a computer, the computer having a storage device configured with a hidden partition and an operating partition, the hidden partition having a bootstrapping program and an operating system loading program stored therein, comprising the steps of:
a) enabling the computer to access the hidden partition of the storage device and to reboot through the bootstrapping program in the hidden partition; and
b) enabling the computer to execute the operating system loading program in the hidden partition so as to load an operating system program to the operating partition of the storage device.

9. The method of claim 8, wherein, in step b), the operating system program is resident beforehand in the hidden partition.

10. The method of claim 9, wherein:
in step a), the computer is provided with a hot key that is operable so as to enable a Basic Input/Output System (BIOS) of the computer to access the hidden partition when the BIOS executes a Power-On Self-Test (POST) in the event that integrity of the operating system program in the operating partition of the storage device has been compromised.

11. The method of claim 8, wherein, in step b), the operating system program is resident beforehand in a computer-readable storage medium.

12. The method of claim 11, wherein the computer-readable storage medium is an optical disc.

13. The method of claim 11, wherein:
in step a), the computer is provided with a hot key that is operable so as to enable a Basic Input/Output System (BIOS) of the computer to access the hidden partition when the BIOS executes a Power-On Self-Test (POST) in the event that integrity of the operating system program in the operating partition of the storage device has been compromised.

14. The method of claim 8, wherein the storage device of the computer is a hard disk.

15. A method for reinstalling an operating system in a computer, the computer including a baseboard management controller and a storage device configured with a hidden partition and an operating partition, the hidden partition having a bootstrapping program and an operating system loading program stored therein, comprising the steps of:
a) configuring the baseboard management controller of the computer to enable a remote system administrator platform to set system boot option parameters;
b) based on the system boot option parameters set by the remote system administrator platform, enabling a Basic Input/Output System (BIOS) of the computer to access the hidden partition, and subsequently enabling the computer to execute the bootstrapping program in the hidden partition; and
c) enabling the computer to provide a service item menu including a set of service items available for selection, and to execute operations associated with a selected one of the service items.

16. The method of claim 15, wherein the service items include “operating system repair through a local optical storage device”, the operations associated therewith including
enabling the BIOS of the computer to execute the operating system loading program in the hidden partition,
enabling the computer to retrieve an operating system program stored in an optical disc that is loaded in an optical disc drive of the computer, and
enabling the computer to load the operating system program to the operating partition of the storage device.

17. The method of claim 15, wherein the service items include “operating system repair through a network optical storage device”, the operations associated therewith including
enabling the BIOS of the computer to execute the operating system loading program in the hidden partition,
through the baseboard management controller of the computer, enabling the computer to retrieve an operating system program stored in an optical disc that is loaded in a network optical disc drive, and
enabling the computer to load the operating system program retrieved through the baseboard management controller to the operating partition of the storage device.

18. The method of claim 15, wherein the storage device of the computer is a hard disk.
